(19) United States
(12) Patent Application Publication
(10) Pub. No.: US 2011/0068587 A1
(43) Pub. Date: Mar. 24, 2011

(54) INTEGRATED LATCH

(75) Inventors: Andrew Lauder, San Francisco, CA (US); Gautam Baksi, San Francisco, CA (US)

(73) Assignee: APPLE INC., Cupertino, CA (US)

(21) Appl. No.: 12/565,604

(22) Filed: Sep. 23, 2009

(51) Int. Cl. E05C 1/10; E05B 15/02

(52) U.S. Cl. 292/175; 292/341.15; 292/340

(57) ABSTRACT

An integrated latch system is described. The integrated latch system including at least a latch, a keeper, and a discrete actuator. In a closed state, the actuator is in direct contact with the keeper and applies a first force to the keeper, the latch applies a second force to the keeper, the first and the second force cooperating to engage the latch and the keeper. In transitioning from the closed state to the open state, a releasing force is applied to the latch, the latch moving at least a predetermined distance in response to the releasing force thereby causing the latch and the keeper to disengage. The actuator applies an ejection force onto the keeper and the keeper moves to an open position in response to the ejection force.

### BACKGROUND OF THE INVENTION

1. Field of the Invention

The described embodiments generally pertain to mechanical fastener that is used to join two (or more) objects or surfaces together while allowing for the regular or eventual separation of the objects or surfaces. In particular, the mechanical fastener is a compact integrated latch system well suited for use in small hand held electronic devices.

2. Description of the Related Art

Many portable electronic devices include enclosures used to contain sensitive electronic components that must be protected from the outside environment. If these enclosures are accessible to a user, then some form of a protection, such as a lid or other such covering, can be used to protect the contents of the enclosure from the outside environment. However, the lid must be able to be removed or at least displaced in order to provide the user with suitable access to the enclosure in order to service any components included therein. For example, if the portable electronic device is powered by replaceable batteries that must be replaced when needed, then the portable electronic device can include an enclosure that can take the form of a battery compartment into which the batteries can be placed. The battery compartment will generally include a lid that can be temporarily removed or set aside in order to provide a user with access to the battery compartment in order to replace any batteries as needed. Generally, the lid is latched into place using a conventional latch system such as that shown in FIG. 1.

FIG. 1 shows conventional latch system 100. Conventional latch system includes keeper 102, latch 104 and lid 106 attached to housing 108 at pivot point P. In a latched state (where lid 106 is in a closed position relative to housing 108), keeper 102 is forced up against latch 104 by restoring force Fᵣ. In order to provide sufficient torque τ on keeper 102 to maintain lid 106 in a closed state, restoring force Fᵣ is provided some distance/from keeper 102 (i.e., τ=F₁×l). For example, if lid 106 is formed of a deformable material, then lid 106 can be considered to include a number of springs distributed along its length that can be approximated as a torsion spring T located at pivot point P with an effective torsion spring coefficient κ_{eff}. In this way, in order to close lid 106, a closing force must be applied to lid 106 that is resisted by torsion spring T (increasing the potential energy U stored in torsion spring T) until keeper 102 is retained, or latched into place by latch 104. The potential energy U stored in torsion spring T by the force applied to close lid 106 can be expressed as equation (1):

$$U = \frac{2}{2} κ {θ}^{2} \qquad equation ( 1 )$$

where κ is torsion spring constant and θ is angle of twist from equilibrium required to maintain lid 104 in the closed state. In this way, restoring force Fᵣ (and the overall latching characteristics of latch system 100) can be seen to be tightly coupled to the material nature and the geometry of lid 106. It is this tight coupling of the characteristics of latch system 100 and the geometry and material of housing 108 that can limit a product designer's ability to provide a finished product with a design that is both aesthetically pleasing and functionally efficient.

Although latch designs generally work well, in many instances it would be desirable to provide an integrated latch system having characteristics that do not unduly burden a product design and that is at least compact in nature and aesthetically pleasing in both the latched and unlatched state.

### SUMMARY OF THE INVENTION

An integrated latch system is described. The integrated latch system including at least a latch, a keeper, and a discrete actuator. In a closed state, the actuator is in direct contact with the keeper and applies a first force to the keeper, the latch applies a second force to the keeper, the first and the second force cooperating to engage the latch and the keeper. In transitioning from the closed state to the open state, a releasing force is applied to the latch, the latch moving at least a predetermined distance in response to the releasing force thereby causing the latch and the keeper to disengage. The actuator applies an ejection force onto the keeper and the keeper moves to an open position in response to the ejection force.

In one embodiment, a method of selectively securing access to a recess in a housing by opening and closing a cover. The method can be carried out by performing at least the following operations. Providing a latch system, the latch system including at least a latch, a keeper coupled to the covering, and a discrete actuator in direct physical contact with the keeper. The latch and the actuator cooperate to maintain the latch system in a closed state and cooperate to transition the latch system to an open state.

A computer is disclosed. The computer includes at least a housing forming an enclosure suitably configured to accommodate computer components, a cover pivotably attached to the housing in proximity to the enclosure, wherein in an open state, the cover allows a user access to the enclosure and wherein in a closed state, the cover prevents user access to the enclosure, and an integrated latch system operable coupled to the housing and the cover that allows the user to open and close the cover. The integrated latch system includes a latch, a keeper coupled to the cover, and a discrete actuator. In a closed state, the actuator is in direct contact with the keeper and applies a first force to the keeper, the latch applies a second force to the keeper, the first and the second force cooperate to engage the latch and the keeper. In transitioning from the closed state to the open state, a releasing force is applied to the latch, the latch moving at least a predetermined distance in response to the releasing force thereby causing the latch and the keeper to disengage, the actuator applying an ejection force onto the keeper, and the keeper moving to an open position in response to the ejection force.

### BRIEF DESCRIPTION OF THE DRAWINGS

The described embodiments are illustrated by way of example, and not by way of limitation, in the figures of the accompanying drawings and in which like reference numerals refer to similar elements and in which:

FIG. 1 shows a conventional latch system.

FIG. 2 shows a state diagram of a latch system in accordance with the described embodiments.

FIG. 3A shows an integrated latch system in accordance with the described embodiments in a closed state.

FIG. 3B shows the integrated latch system of FIG. 3A in an unlatched, closed state.

FIG. 4 shows the integrated latch system of FIG. 3B in an unlatch and open state.

FIG. 5 shows a side and top view of the integrated latch system of FIG. 4.

FIG. 6 shows a flowchart detailing a process in accordance with the described embodiments.

FIGS. 7-9 show various specific embodiments of the integrated latch system.

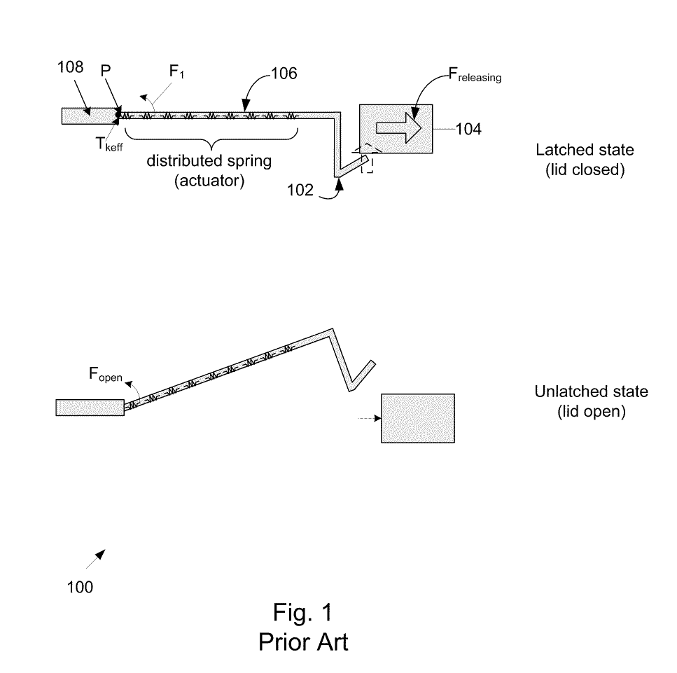

### DETAILED DESCRIPTION OF THE INVENTION

Reference will now be made in detail to selected embodiments an example of which is illustrated in the accompanying drawings. While this application describes several embodiments, it will be understood that it is not intended that there be a preferred embodiment. To the contrary, it is intended to cover alternatives, modifications, and equivalents as can be included within the spirit and scope of the appended claims.

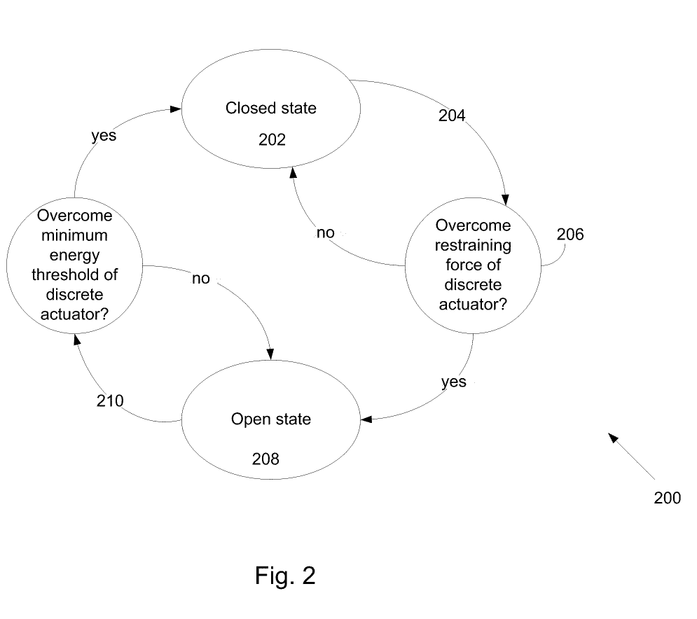

A number of embodiments of an integrated, low profile latch system are discussed. Generally speaking, as shown by state diagram 200 in FIG. 2, the latch system can be in a closed state or an open state at the discretion of a user. In the closed state (202), a discrete actuator co-operates with a latch that directly engages a keeper. The discrete actuator directly applying a retention force to the keeper in the closed state, the keeper being engaged with the latch. The latch applying a restraining force on the keeper that overcomes the retention force to maintain the latch system in the closed state. In transitioning to the open state from the closed state, a releasing force can be applied to the latch (204), if the releasing force is sufficient to overcome the retention force (206), the keeper disengages from the latch and the system transitions to the open state (208), otherwise, the latch system remains in the closed state. In the open state, the (dis-engaged) keeper is acted upon by an ejection force provided by the discrete actuator. The ejection force compelling the keeper to transition to an open position consistent with the open state of the latch system. In transitioning to the closed state from the open state, a closing force is applied to the keeper (210). If the closing force is sufficient to overcome a minimum energy threshold of the discrete actuator (212), then the latch system transitions to the closed state, otherwise it remains in the open state.

In more specific embodiments, an integrated latch system is described. The integrated latch system can be compact in size and present a substantially uniform appearance to a user in both a latched (closed) and an unlatched (open) state. The integrated latch system can have well defined latching characteristics independent of the material properties or the design of the housing. The integrated latch system can include at least a keeper assembly in direct contact with a discrete actuator. The keeper assembly can include a keeper and a lid, or cover, used to conceal a recess in the housing. The recess can be used to temporarily retain components such as a battery. In a latched state, the lid can cover the recess. The discrete actuator can apply a well defined retention force directly on the keeper. The keeper, in turn, can directly engage the latching mechanism that, in turn, can apply a restraining force to the keeper. The restraining force can constrain the keeper from moving in relation to the latching mechanism and the housing. In order to transition to the unlatched state and uncover the recess, a releasing force that overcomes the restraining force can be applied to the latching mechanism. The releasing force can cause the latching mechanism to dis-engage the keeper. In one embodiment the releasing force causes the latching mechanism to translate in the direction of the applied releasing force at least a pre-defined distance. The pre-defined distance being at least sufficient to cause the latching mechanism and the keeper to physically dis-engage. The actuator can apply an ejection force to the dis-engaged keeper that can compel the keeper to move to an open position in relation to latching mechanism and the housing.

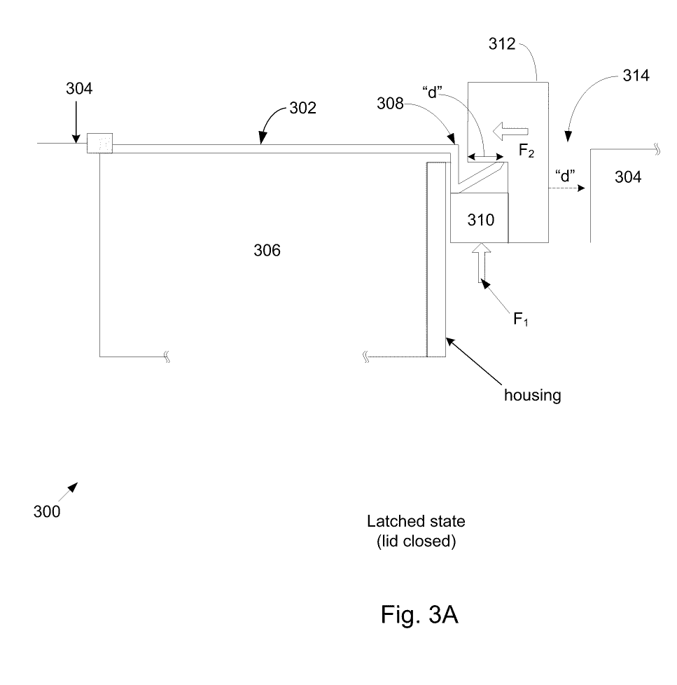

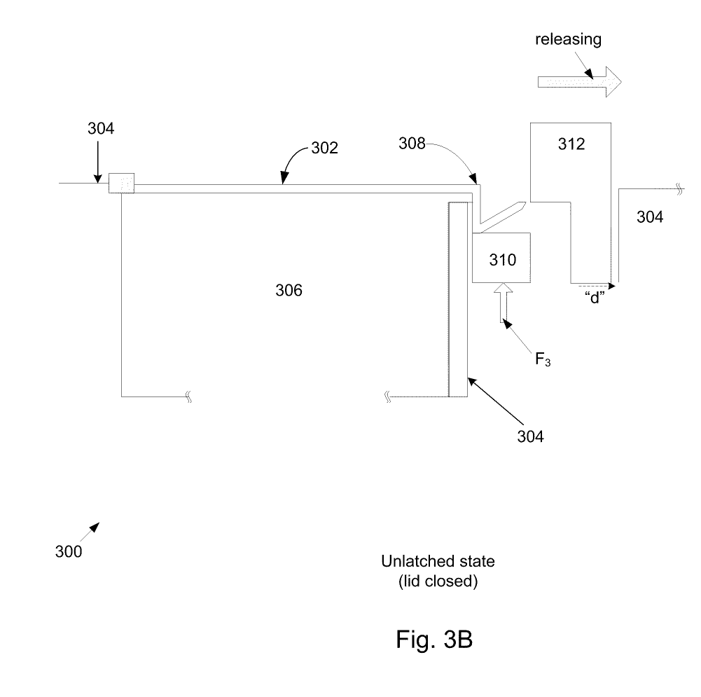

Embodiments of the invention are discussed below with reference to FIGS. 3-9. However, those skilled in the art will readily appreciate that the detailed description given herein with respect to these figures is for explanatory purposes as the invention extends beyond these limited embodiments.

FIG. 3A shows integrated latch system 300 in accordance with the described embodiments. When latch system 300 is in the latched state, lid 302 can be secured to housing 304 thereby covering recess 306. Latch system 300 generally includes keeper 308 and lid 302. In the described embodiment, keeper 308 and lid 302 are integrally formed. Keeper 308 can be in direct contact with actuator 310. Actuator 310 can provide retention force F₁ directly to keeper 308. Retention force F₁ can be provided by any number of different force producing mechanisms. In one embodiment retention force F₁ can be provided by a spring mechanism, such as a compression spring. In other embodiment, retention force F₁ can be provided by an electromechanical mechanism. In any case, retention force F₁ can be provided in any manner deemed appropriate and suitable for the product at hand. In a latched state, keeper 308 and latch 312 can be engaged. In the described embodiment, keeper 308 can be in direct physical contact with latch 312. Latch 312 can exert restraining force F₂ on keeper 308. In a stable, closed configuration restraining force F₂ can overcome retention force F₁ such that the keeper remains engaged with latch 312. In this way, lid 302 can remain in a closed position preventing access to recess 304.

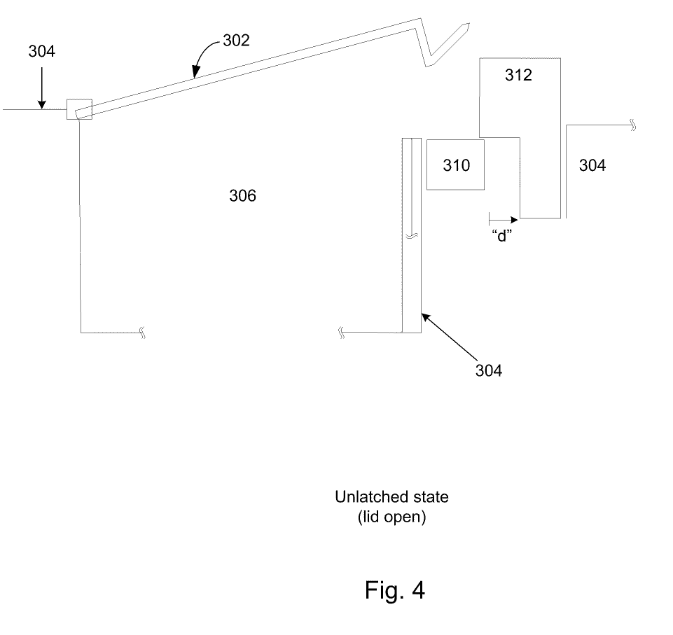

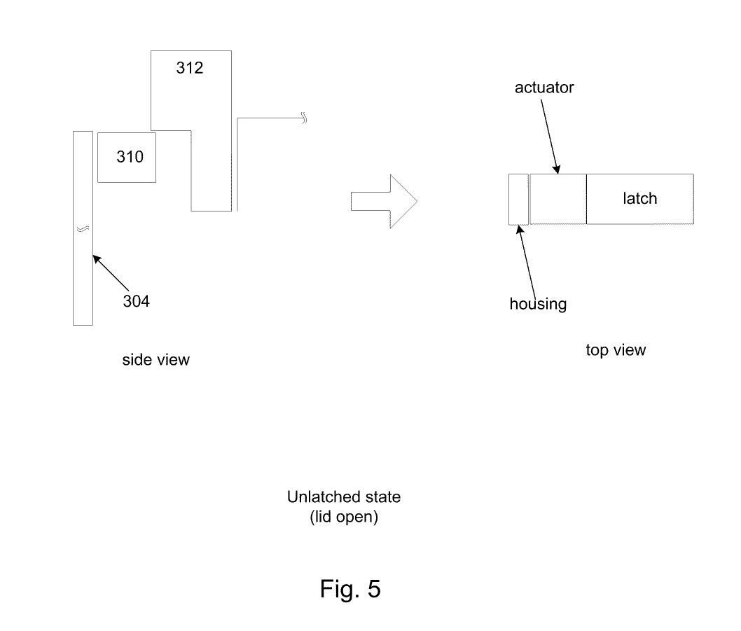

Latch 312 can be received by latch receiving area 314 that can be formed as part of housing 304. Latch 312 and latch receiving area 314 can be cooperatively positioned and sized so that when lid 302 is closed, both latch 312 and latch receiving area 314 can engage with one another thus securing lid 302 to housing 304. As shown, latch 312 can protrude from a top portion of housing 304 and latch receiving area 314 can be located in a portion of housing 304 suitable for receiving latch 312 when latch 312 is horizontally translated at least distance “d” to disengage keeper 308. Latch 312 and latch receiving area 314 can be widely varied. For example, latch 312 may be movably affixed to housing 304. In this way, as shown in FIG. 3B, a user can indirectly open lid 302 by applying releasing force F₂ that can cause latch 312 to translate approximately distance “d” into latch receiving area 314. In the described embodiment, latch system 300 can be configured such that latch 312 and keeper 308 can disengage only when latch 312 moves at least distance “d” into receiving area 314. Once keeper and latch 312 disengage, actuator 310 can exert ejecting force F₃ on keeper 308. Ejecting force F₃ can compel keeper 308 to move in relation to latch 312 and housing 304 to open position as shown in FIG. 4. In this way, lid 302 can move and uncover recess 306. As shown in FIG. 5 (with lid 302 removed for clarity), actuator 310 and latch 312 can form what appears to be from a top view a substantially uniform extension of housing 304 once keeper 308 and latch 312 disengage. In this way, the substantially uniform appearance can enhance the aesthetic look and feel of housing 304 since a user's eye is not attracted to nor distracted by latch system 300.

As discussed above, actuator 310 can take many forms. In some embodiments, a spring mechanism along the lines of a compression spring can be incorporated in or coupled with actuator 310. In so doing, when a user wishes to close lid 302, the user applies a closing force F_{close} to lid 302 that, in turn, forces keeper 308 to move actuator 310 distance “x”. In this way, potential energy (U) can then stored in the compression spring of actuator 310 according to equation (2)

U=1/2kx² eq (2)
where k: is spring coefficient of the compression spring,
   x: is the displacement of actuator.
      Potential energy U can be imparted to lid 302 when keeper 308 and latch 312 are subsequently disengaged.

Clearly, operating characteristics of latch system 300 are only dependent upon the properties of actuator 310, namely, the spring coefficient k. In contrast, conventional latch system 100 exhibits behavior that is dependent on both the material used to form the lid (k_{eff}) and the design of the housing (the allowable θ). By providing a discrete actuator having its own characteristics that can be established with little or no consideration of the material used to fabricate housing 302, there can be little or no coupling between the properties of latch system 300 and that of housing 304. In this way, the product designer is given substantially greater latitude in the industrial design aspects of any products that utilize latch system 300.

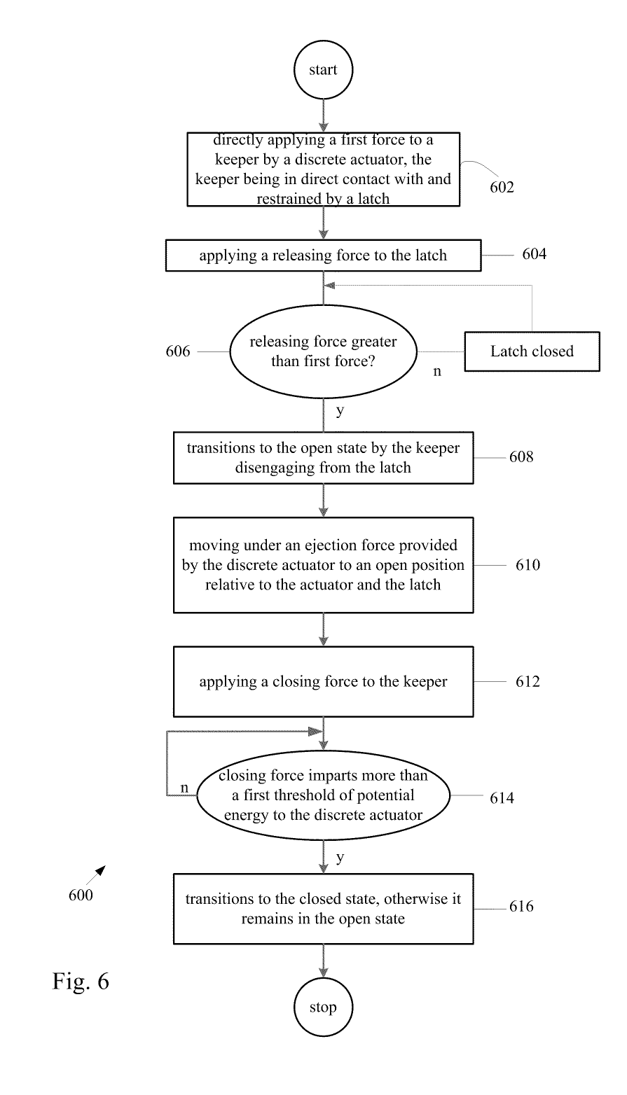

FIG. 6 shows a flowchart detailing process 600 for controlling a state of an integrated latch system in accordance with the described embodiments. Process 600 can be carried out by performing at least the following operations. In a closed state at 602, directly applying a first force to a keeper by a discrete actuator, the keeper being in direct contact with and restrained by a latch. The latch applying a second force on the keeper that overcomes the first force directly applied by the actuator. In order to transition from the closed state to an open state, applying a releasing force to the latch at 604. If, at 606, it is determined that the releasing force does not overcome the first force, then the integrated latch system remains in the closed state, otherwise the integrated latch system transitions to the open state by the keeper disengaging from the latch at 608 and moving under an ejection force provided by the discrete actuator to an open position relative to the actuator and the latch at 610. In transitioning to the closed state from the open state, applying a closing force to the keeper at 612. If it is determined at 614 that the closing force imparts more than a first threshold of potential energy to the discrete actuator, then at 616 the latch system transitions to the closed state, otherwise it remains in the open state.

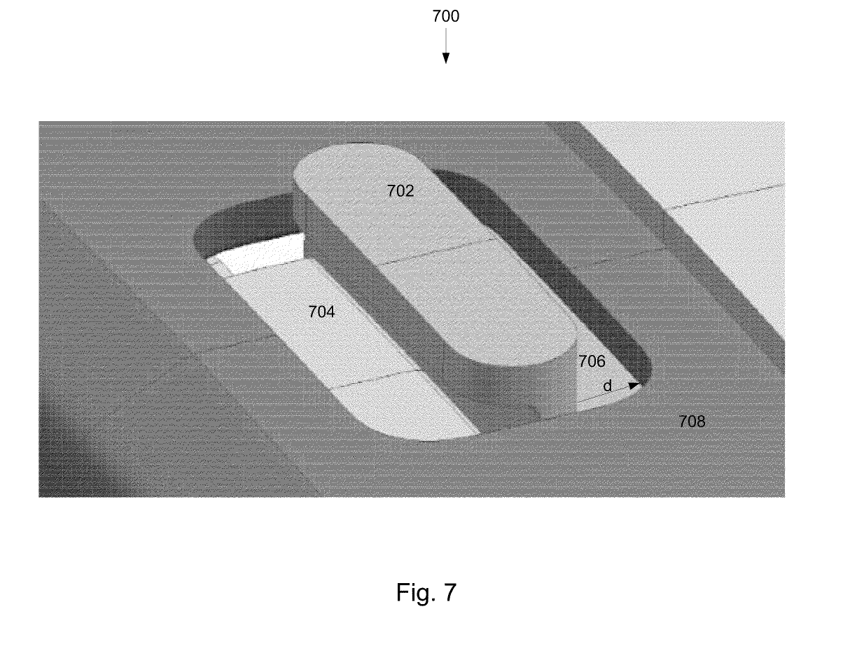

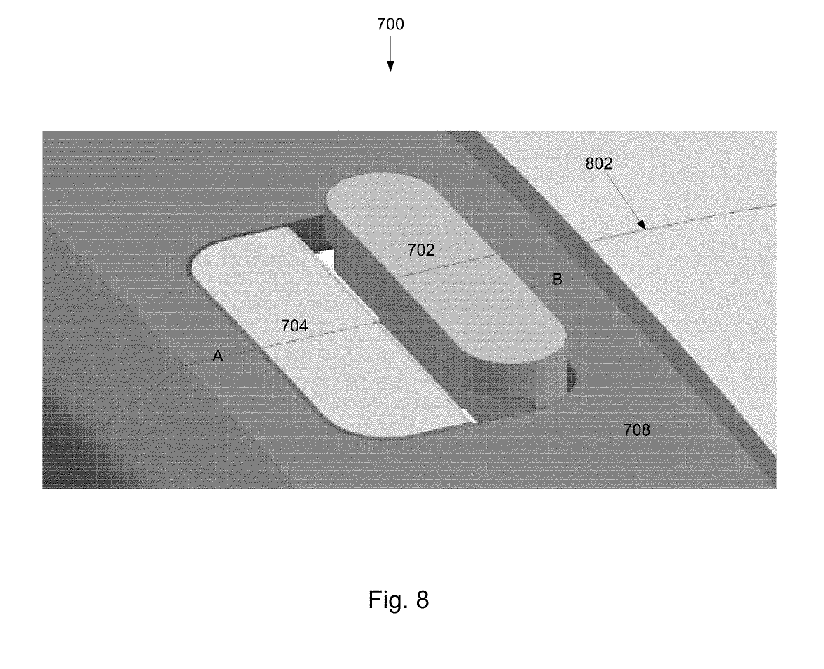

FIGS. 7-9 illustrates various views, both internal and external, of representative integrated latch system in accordance with the described embodiments. FIGS. 7 and 8 show perspective views of latch system 700 in an open state and a closed state, respectively. Latch system 700 can include latch 702, keeper 704, latch receiving area 706 formed from housing 708. As shown in FIG. 7, latch 702 can engage keeper 704 in a latched state. Latch receiving area 706 being co-operatively formed with housing 708 can allow latch 702 to translate a distance “d” sufficient to allow keeper 704 and latch 702 to disengage in transitioning to an unlatched state as shown in FIG. 8. It should be noted that as viewed from the top, latch system 700 in FIG. 8 appears to be uniform in nature. For example, reference line 802 would appear to an observer to be substantially unbroken from point A to point B and therefore would substantially blend in with housing 708 if the particular product design determined that to be desirable.

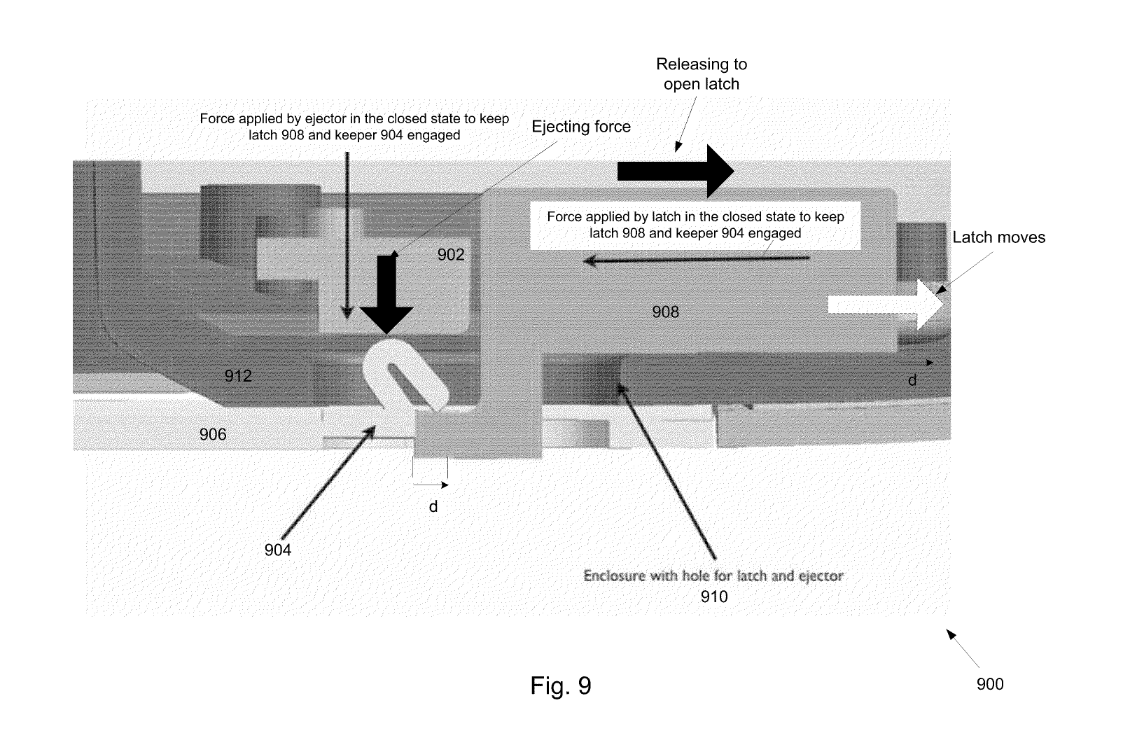

FIG. 9 shows integrated latch system 900 suitable for latching/unlatching a door found on, for example, a computer. In a closed, or latched state, spring based actuator also referred to as ejector 902 applies retention force on keeper 904. Keeper 904 being integrally formed with door 906. Latch 908 applies restraining force directly onto keeper 904. In order to transition to an open state, a releasing force is applied to latch 908 that can overcome the restraining force causing latch 908 to laterally translate toward and into enclosure 910 at least a distance d. The distance d being sufficient to at least disengage latch 908 and keeper 904. Enclosure 910 being configured to accommodate at least latch 908 and ejector 902. Latch 908 and keeper 904 disengage and ejector 902 applies an ejecting force directly onto keeper 904. The ejecting force causing keeper 904 and door 906 to move to an open position relative to housing 912. In order to transition from the open state to the closed state, a closing force is applied to keeper 904 (or door 906) causing the potential energy of the spring associated with ejector 902 to increase. If the increase in potential energy is greater than a first threshold, then latch system 900 transitions to the closed state, otherwise latch system 900 remains in the open state.

While this invention has been described in terms of several preferred embodiments, there are alterations, permutations, and equivalents, which fall within the scope of this invention. For example, although the invention is primarily directed at a recess found in portable electronic devices, the invention can be well suited for other applications.

What is claimed is:

1. An integrated latch system, comprising:
a latch;
a keeper; and
a discrete actuator, wherein in a closed state, the actuator being in direct contact with the keeper and applying a first force to the keeper, the latch applying a second force to the keeper, the first and the second force cooperating to engage the latch and the keeper, wherein transitioning from the closed state to the open state, a releasing force is applied to the latch, the latch moving at least a predetermined distance in response to the releasing force thereby causing the latch and the keeper to disengage, the actuator applying an ejection force onto the keeper, and the keeper moving to an open position in response to the ejection force.

2. The integrated latch system as recited in claim 1, wherein the integrated latch system is incorporated into a housing, wherein the housing, the latch, and the keeper are formed of the same material.

3. The integrated latch system as recited in claim 2, wherein in the unlatched state, the latch and the keeper appear to be an integral portion of the housing.

4. The integrated latch system as recited in claim 1, wherein the keeper is integrally connected with a covering.

5. The integrated latch system as recited in claim 4, wherein the covering is used to cover a recess in a housing when the latch system is in the latched state and to uncover the recess when the latch system is in the unlatched state.

6. A method of selectively securing access to a recess in a housing by opening and closing a cover, comprising:
providing a latch system, the latch system including at least a latch, a keeper coupled to the covering, and a discrete actuator in direct physical contact with the keeper, wherein the latch and the actuator cooperate to maintain the latch system in a closed state and cooperate to transition the latch system to an open state.

7. The method as recited in claim 6, further comprising:
in the closed state,
applying a first force directly to the keeper by the actuator; and
applying a second force directly to keeper by the latch, wherein the first and the second forces cooperate to maintain the keeper and the latch engaged.

8. The method as recited in claim 7, further comprising:
transitioning from the closed state to the open state by,
applying a releasing force directly to the latch;
moving the latch at least a pre-determined distance in response to the applied releasing force;
disengaging the latch and the keeper;
directly applying an ejection force by the actuator; and
moving the keeper to an open position in response to the applied ejection force.

9. The method as recited in claim 6, wherein the housing is a computer housing.

10. A computer, comprising:
a housing forming an enclosure suitably configured to accommodate computer components;
a cover pivotably attached to the housing in proximity to the enclosure, wherein in an open state, the cover allows a user access to the enclosure and wherein in a closed state, the cover prevents user access to the enclosure; and
an integrated latch system operable coupled to the housing and the cover that allows the user to open and close the cover, the integrated latch system comprising:
a latch,
a keeper coupled to the cover, and
a discrete actuator, wherein in a closed state, the actuator being in direct contact with the keeper and applying a first force to the keeper, the latch applying a second force to the keeper, the first and the second force cooperating to engage the latch and the keeper, wherein transitioning from the closed state to the open state, a releasing force is applied to the latch, the latch moving at least a predetermined distance in response to the releasing force thereby causing the latch and the keeper to disengage, the actuator applying an ejection force onto the keeper, and the keeper moving to an open position in response to the ejection force.

11. The computer as recited in claim 10, wherein the integrated latch system is incorporated into a housing, wherein the housing, the latch, and the keeper are formed of the same material.

12. The computer as recited in claim 11, wherein in the unlatched state, the latch and the keeper appear to be an integral portion of the housing.
